(19) United States
(12) Patent Application Publication
(10) Pub. No.: US 2012/0308236 A1
(43) Pub. Date: Dec. 6, 2012

(54) APPARATUS FOR INTERFACING BETWEEN DUAL-CARRIER OPTICAL TRANSCEIVER AND WDM OPTICAL TRANSMISSION LINE

(75) Inventors: Sun Hyok CHANG, Daejeon (KR); Hwan Seok CHUNG, Daejeon (KR)

(73) Assignee: Electronics and Telecommunications Research Institute, Daejeon (KR)

(21) Appl. No.: 13/464,837

(22) Filed: May 4, 2012

(30) Foreign Application Priority Data
May 30, 2011 (KR) 10-2011-0051420

(51) Int. Cl. H04J 14/02

(52) U.S. Cl. 398/79

(57) ABSTRACT

The present invention provides an interface apparatus between a dual-carrier optical transceiver and a WDM (wavelength division multiplexing) optical transmission line, including: an optical multiplexer configured to receive a first optical signal modulated by a first optical carrier and a second optical signal modulated by a second optical carrier from the dual-carrier optical transceiver, and multiplex the first optical signal and the second optical signal to output the signals to the optical transmission line; and an optical demultiplexer configured to receive the multiplexed optical signal from the optical transmission line and demultiplex the multiplexed optical signal to output the signals to the dual-carrier optical transceiver.

### CROSS-REFERENCE TO RELATED APPLICATIONS

This application claims priority to and the benefit of Korean Patent Application No. 10-2011-0051420 filed in the Korean Intellectual Property Office on May 30, 2011, the entire contents of which are incorporated herein by reference.

### TECHNICAL FIELD

The present invention relates to an optical communication system, and more specifically, to an apparatus for interfacing between a dual-carrier optical transceiver and a WDM (wavelength division multiplexing) optical transmission line.

### BACKGROUND ART

In order to satisfy the demands for a broad bandwidth at a point where data traffic is concentrated such as a high performance computer, a server, a data center, an enterprise network, or an Internet exchange center, a signal of 40G or higher per wavelength appears. Further, as 40G Ethernet or 100G Ethernet technology is standardized, researches for a technology of transmitting the signals using a WDM optical transmission network over a long distance have been actively studied.

In order to transmit the high speed signal, multi-level modulation formats that are capable of transmitting 2 bits or more per symbol are focused. Among the modulation methods, a QPSK (quadrature phase shift keying) format that can transmit 2 bits per symbol is mostly studied. In the case of the QPSK format, if the bit rate is B, since a symbol rate is a bit rate that is divided by the number of bits that can be transmitted with the individual symbols, the symbol rate becomes B/2. Therefore, it is required include electro-optic devices whose a bandwidth is half the bit rate.

When using a DP-QPSK (dual polarization-quadrature phase shift keying) format that simultaneously uses the dual polarization states of an optical signal and the QPSK format, a QPSK signal is transmitted in each polarization state, respectively, so that the symbol rate is lowered to B/4. Therefore, the bandwidth of the used electro-optic devices can be reduced. However, since the phase of the optical signal needs to be detected in order to separate the individual polarized signals and restore the signals, an ADC (analog to digital converter) that operates at a high speed and a high speed DSP (digital signal processor) are required to be provided at a receiving stage.

In the meantime, a DP-DQPSK (dual polarization-differential quadrature phase shift keying) format that reduces the symbol rate to B/4 using a polarization property of the optical signal without using ADC and the DSP is suggested. Since the DP-DQPSK method uses a delay interferometer at a receiving stage to receive the optical signal by converting a phase modulation of the optical signal into an amplitude modulation, the ADC and DSP are not required. However, a complex polarization controller is required to separate the polarization states at the receiving stage.

In order to solve the above-described problems, the applicants of the present invention have suggested a dual-carrier optical transceiver (Korean Patent Application No. 10-2009-0067998 filed on Jul. 24, 2009 and entitled “Optical transmitting and receiving apparatus using dual-carrier differential Quadrature phase shift keying”). If a signal is modulated into a QPSK signal and transmitted/received by a carrier using a dual-carrier method, the symbol rate becomes B/4 and an electrical bandwidth becomes a quarter of the bit rate. Further, the ADC, the DSP, and the polarization controller are not used, which results in a simplified structure of the optical transceiver.

### SUMMARY OF THE INVENTION

The exemplary embodiments of the present invention provides an interface apparatus that interfaces between a dual-carrier optical transceiver and a WDM optical transmission line in order to use the dual-carrier optical transceiver in a WDM optical transmission system.

An exemplary embodiment of the present invention provides an interface apparatus between a dual-carrier optical transceiver and a WDM (wavelength division multiplexing) optical transmission line, including: an optical multiplexer configured to receive a first optical signal modulated by a first optical carrier and a second optical signal modulated by a second optical carrier from the dual-carrier optical transceiver, and multiplex the first optical signal and the second optical signal to output the signals to the optical transmission line; and an optical demultiplexer configured to receive the multiplexed optical signal from the optical transmission line and demultiplex the multiplexed optical signal to output the signals to the dual-carrier optical transceiver.

A channel wavelength of the optical multiplexer may include a wavelength of the first optical carrier and a wavelength of the second optical carrier.

A channel spacing of the multiplexer may be 50 GHz or 100 GHz.

Another exemplary embodiment of the present invention provides an interface apparatus between a dual-carrier optical transceiver and an optical transmission line, including: a first optical multiplexer configured to receive a first optical signal modulated by a first optical carrier from the dual-carrier optical transceiver, and multiplex the first optical signal together with another optical signal to output the signals; a second optical multiplexer configured to receive a second optical signal modulated by a second optical carrier from the dual-carrier optical transceiver, and multiplex the second optical signal together with another optical signal to output the signals; and an optical interleaver configured to multiplex an output of the first multiplexer and an output of the second multiplexer to output the outputs to the optical transmission line.

A channel spacing of the first optical multiplexer and the second optical multiplexer may be twice a channel spacing of the optical interleaver.

Channel frequencies of the first optical multiplexer and the second optical multiplexer may be spaced apart from each other.

A channel spacing of the first optical multiplexer and the second optical multiplexer may be 100 GHz, channel frequencies may be spaced apart from each other by 50 GHz, and a channel spacing of the optical interleaver may be 50 GHz.

A channel wavelength of the first optical multiplexer may include a wavelength of the first optical carrier and a channel wavelength of the second optical multiplexer may include a wavelength of the second optical carrier.

Yet another exemplary embodiment of the present invention provides an interface apparatus between a dual-carrier optical transceiver and an optical transmission line, including: an optical interleaver configured to receive a first optical signal modulated by a first optical carrier and a second optical signal modulated by a second optical carrier from the dual-carrier optical transceiver, and multiplex the first optical signal and the second optical signal to output the signals; and an optical multiplexer configured to multiplex and output an output to the optical interleaver together with another optical signal.

Two input frequencies corresponding to two input wavelengths of the optical interleaver may be spaced apart from each other at a predetermined interval at both sides with a specific channel frequency of the optical multiplexer at a center thoseof.

Two input frequencies corresponding to two input wavelengths of the optical interleaver may be spaced apart by a frequency smaller than half of a channel spacing of the optical multiplexer at both sides with a specific channel frequency of the optical multiplexer at a center thoseof.

Two input wavelengths of the optical interleaver may correspond to wavelengths of the first optical carrier and the second optical carrier.

A channel spacing of the optical multiplexer may be 100 GHz, and two input frequencies corresponding to two input wavelengths of the optical interleaver may be spaced apart by 25 GHz at both sides with a specific channel frequency of the optical multiplexer at a center thoseof.

The dual-carrier optical transceiver and the optical interleaver may be provided in the same line card.

The dual-carrier optical transceiver and the optical interleaver may be provided in separate line cards.

The optical interleaver and the optical multiplexer may be provided in the same line card.

According to exemplary embodiments of the present invention, a dual carrier optical transceiver and a WDM optical transmission line can be efficiently interfaced in order to use the dual-carrier optical transceiver in the WDM optical transmission system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a configuration of a dual-carrier optical transceiver.

FIG. 2 shows a configuration of an interface apparatus between a dual-carrier optical transceiver and a WDM optical transmission line according to an exemplary embodiment of the present invention.

FIG. 3 shows an example of a channel spectrum of an output of an optical multiplexer 230 when a channel spacing of the optical multiplexer 230 is 50 GHz.

FIG. 4 shows an example of a channel spectrum of an output of the optical multiplexer 230 when a channel spacing of the optical multiplexer 230 is 100 GHz.

FIG. 5 shows a configuration of an interface apparatus between a dual-carrier optical transceiver and a WDM optical transmission line according to another exemplary embodiment of the present invention.

FIG. 6 shows an example of a channel spectrum of outputs of a first optical multiplexer 530, a second optical multiplexer 540, and an optical interleaver 550.

FIG. 7 shows a configuration of an interface apparatus between a dual-carrier optical transceiver and a WDM optical transmission line according to another exemplary embodiment of the present invention.

FIG. 8 shows an example of spectrums of two input optical signals of an optical interleaver 720, a spectrum of an output optical signal of the optical interleaver 720, and a channel spectrum of an output of an optical multiplexer 730.

FIG. 9 shows a configuration of an interface apparatus between a dual-carrier optical transceiver and a WDM optical transmission line according to still another exemplary embodiment of the present invention.

FIG. 10 shows a configuration of an interface apparatus between a dual-carrier optical transceiver and a WDM optical transmission line according to still yet another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Prior to describing an interface apparatus between a dual-carrier optical transceiver and a WDM optical transmission line according to an exemplary embodiment of the present invention, a dual-carrier optical transceiver to which the present invention is applied will be described.

Hereinafter, throughout the specification, an optical multiplexer is a reversible element, so that the optical multiplexer may be used as an optical demultiplexer depending on an operation mode or an installed position. Further, an optical interleaver is also a reversible element, so that the optical interleaver may be used as an optical de-interleaver depending on an operation mode or an installed position.

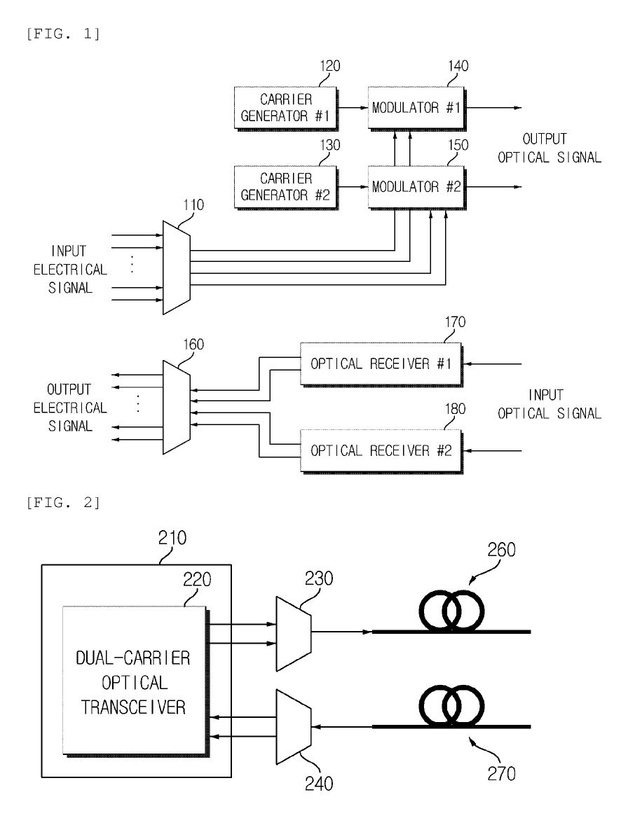

FIG. 1 shows a configuration of a dual-carrier optical transceiver. The dual-carrier optical transceiver, as shown in FIG. 1, includes a serializer 110, carrier generators #1 and #2 120 and 130, modulators #1 and #2 140 and 150, a parallerizer 160, and optical receivers #1 and #2 170 and 180.

The serializer 110 multiplexes a plurality of electrical signals to be input into four high speed electrical signals to output one pair of electrical signals to the modulator #1 140 and output the other pair of electrical signals to the modulator #2 150.

The carrier generators #1 and #2 120 and 130 generate first and second optical carriers having different wavelengths to output the carriers to the modulators #1 and #2 140 and 150.

The modulator #1 140 modulates one pair of electrical signals among the four electrical signals using the first optical carrier to output a first optical signal, and the modulator #2 150 modulates the other pair of electrical signals among the four electrical signals using the second optical carrier to output a second optical signal. The first optical signal and the second optical signal are signals to be output to an optical transmission line.

A first received optical signal and a second received optical signal that are transmitted through the optical transmission line over a long distance are input to the dual carrier optical transceiver. The first received optical signal and the second received optical signal are modulated by the first optical carrier and the second optical carrier, respectively. The optical receiver #1 170 receives the first received optical signal and modulates the first received optical signal to output a pair of electrical signals to the parallerizer 160. The optical receiver #2 180 receives the second received optical signal and modulates the second received optical signal to output the other pair of electrical signals to the parallerizer 160.

The parallerizer 160 demultiplexes the two pairs of electrical signals to output a plurality of low speed electrical signals.

For example, in the case of a dual-carrier optical transceiver that transmits and receives a bit rate of 112 Gbps, an input electrical signal is configured by 11.2 Gbps×10 lanes, and multiplexed to 28 Gbps×4 lanes by the serializer 110. If the QPSK is used as a modulation method, two 28 Gbps electrical signals are input to the modulators #1 and #2 140 and 150 and QPSK-modulated by the first and second optical carriers.

In the optical receivers #1 and #2 170 and 180 at the receiving stage, the received optical signals are converted again into the electrical signals using a DQPSK (differential QPSK) receiver that receives the QPSK modulated signal using a differential detection method. The optical receivers #1 and #2 170 and 180 output two 28 Gbps electrical signals. Four 28 Gbps electrical signals are demultiplexed by the parallerizer 160 to obtain 11.2 Gbps×10 lanes of output electrical signals.

As described above, two optical signals are output from the dual-carrier optical transceiver and two optical signals are input thereto.

In order to use the dual-carrier optical transceiver in a WDM optical transmission system, the optical output/input should be interfaced with a wavelength channel of the WDM optical transmission system. Hereinafter, an interface apparatus between a dual-carrier optical transceiver and a WDM optical transmission line according to exemplary embodiments of the present invention will be described.

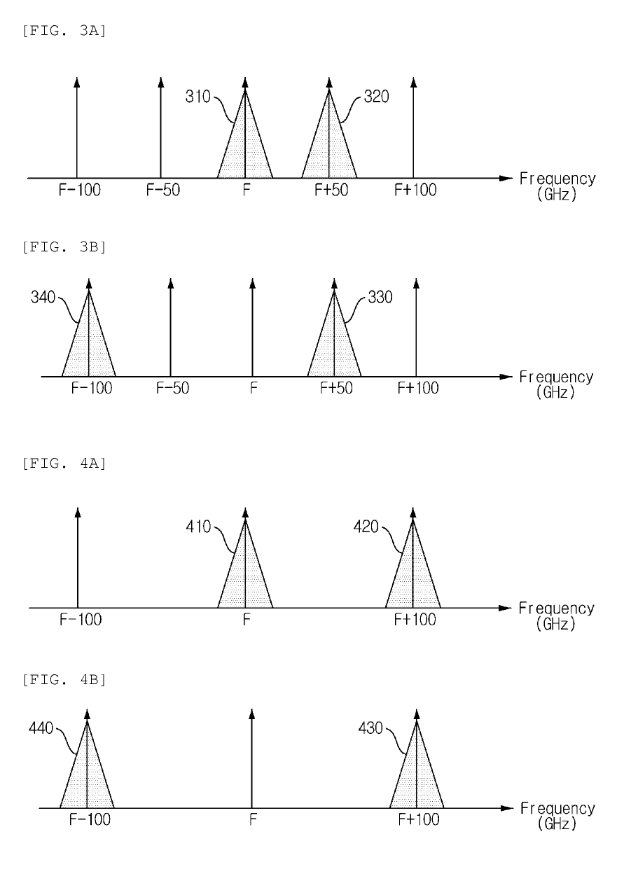

FIG. 2 shows a configuration of an interface apparatus between a dual-carrier optical transceiver and a WDM optical transmission line according to an exemplary embodiment.

The dual-carrier optical transceiver 220 is configured by one module that is generally referred to as an optical transceiver and may be provided in a line card 210 in the WDM optical transmission system. Even though not shown, the line card 210 may include not only the dual-carrier optical transceiver 220 but also a framer device or a FEC (forward error correction) device in order to improve the transmission performance.

Referring to FIG. 2, optical outputs of the dual-carrier optical transceiver 220 are two optical signals, that is, a first optical signal modulated by the first optical carrier and a second optical signal modulated by the second optical carrier. Further, optical inputs of the dual-carrier optical transceiver 220 are two received optical signals, that is, a first received optical signal modulated by the first optical carrier and a second received optical signal modulated by the second optical carrier. The two optical inputs/outputs of the dual-carrier optical transceiver 220 configure inputs/outputs of the line card 210.

The optical multiplexer 230 receives the first optical signal and the second optical signal from the dual-carrier optical transceiver 220 and multiplexes the first optical signal and the second optical signal to output the signals to the optical transmission line 260. Further, even though not shown, the optical multiplexer 230 receives an optical signal from a dual-carrier optical transceiver other than the dual-carrier optical transceiver 220 or a general optical transceiver together with the first optical signal and the second optical signal and multiplexes the optical signals to output the signals to the optical transmission line 260.

The optical demultiplexer 240 receives an optical signal that is multiplexed from the first received optical signal and the second received optical signal from the optical transmission line 270 and demultiplexes the received optical signal to output the first received optical signal and the second received optical signal to the dual-carrier optical transceiver 220. The optical signals that are input to the optical demultiplexer 240 from the optical transmission line 270 are also signals multiplexed together with not only the first received optical signal and the second received optical signal but also the other optical signal. Therefore, even though not shown, the output of the optical demultiplexer 240 may include other optical signals in addition to the first received optical signal and the second received optical signal, and become an input of a dual-carrier optical transceiver other than the dual-carrier optical transceiver 220 or a general optical transceiver.

In a WDM optical transmission system, a channel spacing of the wavelength division multiplexed optical signal is generally 50 GHz or 100 GHz, and an absolute value of the used channel wavelength applies an ITU-T grid standardized by ITU-T.

The channel wavelength and the channel spacing of the optical multiplexer 230 and the optical demultiplexer 240 of FIG. 2 apply the ITU-T Grid. For example, the channel spacing is 50 GHz or 100 GHz. Further, the wavelength of the first optical carrier and the wavelength of the second optical carrier are included in the channel wavelength of the optical multiplexer 230 or the optical demultiplexer 240.

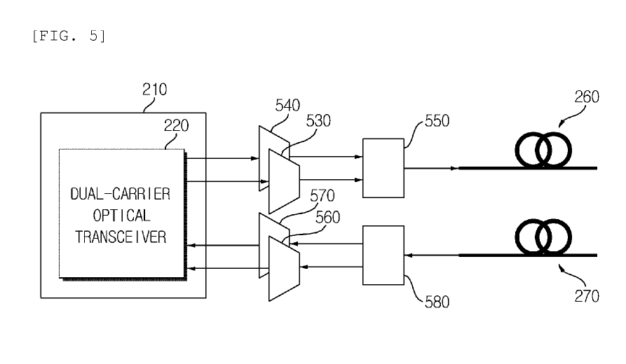

FIG. 3 shows an example of a channel spectrum of an output of the optical multiplexer 230 when a channel spacing of the optical multiplexer 230 is 50 GHz. In FIGS. 3, F−100, F−50, F, F+50, and F+100 denote channel frequencies corresponding to channel wavelengths of the optical multiplexer 230. FIG. 3A shows a case of selecting wavelengths of the first optical carrier and the second optical carrier so that the first optical signal 310 and the second optical signal 320 of the dual-carrier optical transceiver 220 correspond to adjacent channels. In other words, the frequencies corresponding to the wavelengths of the first optical carrier and the second optical carrier are F and F+50. FIG. 3B shows a case of selecting wavelengths of the first optical carrier and the second optical carrier so that the first optical signal 330 and the second optical signal 340 of the dual-carrier optical transceiver 220 correspond to channels that are not adjacent. In other words, the frequencies corresponding to the wavelengths of the first optical carrier and the second optical carrier are F+50 and F−100.

FIG. 4 shows an example of a channel spectrum of an output of the optical multiplexer 230 when a channel interval of the optical multiplexer 230 is 100 GHz. In FIGS. 4, F−100, F, and F+100 denote channel frequencies corresponding to the channel wavelengths of the optical multiplexer 230. FIG. 4A shows a case of selecting wavelengths of the first optical carrier and the second optical carrier so that the first optical signal 410 and the second optical signal 420 of the dual-carrier optical transceiver 220 correspond to adjacent channels. In other words, the frequencies corresponding to the wavelengths of the first optical carrier and the second optical carrier are F and F+100. FIG. 4B shows a case of selecting wavelengths of the first optical carrier and the second optical carrier so that the first optical signal 430 and the second optical signal 440 of the dual-carrier optical transceiver 220 correspond to channels that are not adjacent. In other words, the frequencies corresponding to the wavelengths of the first optical carrier and the second optical carrier are F+100 and F−100.

As described above, the optical signal obtained by multiplexing the first optical signal and the second optical signal is transmitted through the optical transmission line 260 over a long distance.

In the receiving process, contrary to the transmitting process, the multiplexed optical signal, as shown in FIG. 3A or 3B, or FIG. 4A or 4B, is input to the optical demultiplexer 240 and the optical demultiplexer 240 demultiplexes the optical signal to output to the dual-carrier optical transceiver 220. Two demultiplexed optical signals are received by the dual-carrier optical transceiver 220.

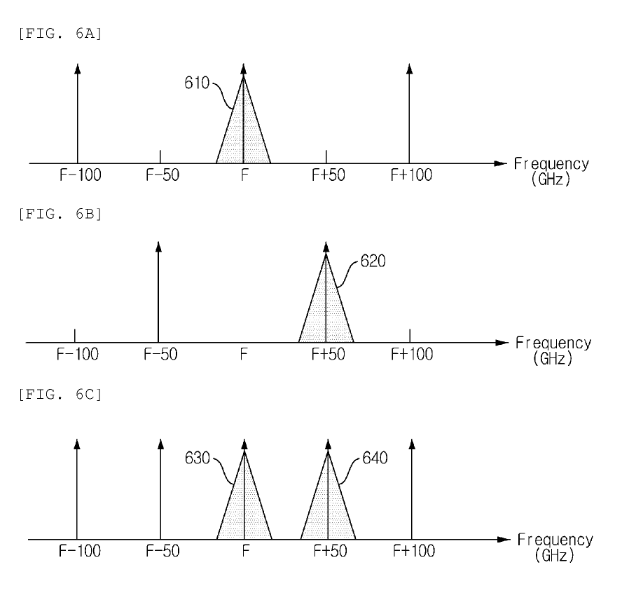

FIG. 5 shows a configuration of an interface apparatus between a dual-carrier optical transceiver and a WDM optical transmission line according to another exemplary embodiment of the present invention.

A first optical multiplexer 530 receives a first optical signal from the dual-carrier optical transceiver 220. Even though not shown, the first optical multiplexer 530 receives an optical signal from a dual-carrier optical transceiver other than the dual-carrier optical transceiver 220 or a general optical transceiver together with the first optical signal and multiplexes the input optical signals to output the signals to an optical interleaver 550.

A second optical multiplexer 540 receives a second optical signal from the dual-carrier optical transceiver 220. Even though not shown, the second optical multiplexer 540 receives an optical signal from a dual-carrier optical transceiver other than the dual-carrier optical transceiver 220 or a general optical transceiver together with the second optical signal and multiplexes the input optical signals to output the signals to the optical interleaver 550.

The optical interleaver 550 multiplexes the multiplexed optical signal from the first optical multiplexer 530 and the multiplexed optical signal from the second optical multiplexer 540 again and outputs the optical signals to the optical transmission line 260.

An optical de-interleaver 580 receives an optical signal obtained by multiplexing the first received optical signal and the second received optical signal from the optical transmission line 270 and demultiplexes the optical signal to output the first received optical signal and the second received optical signal to a first optical demultiplexer 560 and a second optical demultiplexer 570, respectively. Here, the first received optical signal is a multiplexed signal and the second received optical signal is also a multiplexed signal. The optical demultiplexer 560 demultiplexes the first received optical signals and outputs one of the signals to the dual-carrier optical transceiver 220. The optical demultiplexer 570 demultiplexes the second received optical signals and outputs one of the signals to the dual-carrier optical transceiver 220. The other optical signals demultiplexed by the optical demultiplexer 560 and the optical demultiplexer 570 become an input of a dual-carrier optical transceiver other than the dual-carrier optical transceiver 220 or a general optical transceiver.

In this exemplary embodiment, the channel spacing of the first and second optical multiplexers/demultiplexers 530, 540, 560, and 570 is twice that of the WDM optical transmission system, and the channel spacing of the optical interleaver/de-interleaver 550 and 580 is the same as that of the WDM optical transmission system. For example, when a WDM optical transmission system having a channel spacing of 50 GHz is configured, the channel spacing of the first and second optical multiplexers/demultiplexers 530, 540, 560, and 570 is 100 GHz. In this case, the second optical multiplexer/demultiplexer 540 and 570 have a channel frequency corresponding to the channel wavelength that is spaced apart by 50 GHz as compared with the first optical multiplexer/demultiplexer 530 and 560. The optical interleaver/de-interleaver 550 and 580 have a channel spacing of 50 GHz, and the channel wavelength of the optical interleaver/de-interleaver 550 and 580 includes the channel wavelength of the first and second optical multiplexers/demultiplexers 530, 540, 560, and 570. The wavelength of the first optical carrier is included in the channel wavelength of the first optical multiplexer 530 and the wavelength of the second optical carrier is included in the channel wavelength of the second optical multiplexer 540.

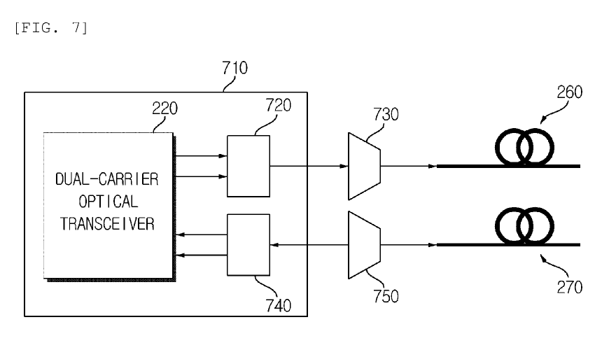

FIG. 6A shows an example of a channel spectrum of an output of the first optical multiplexer 530, FIG. 6B shows an example of a channel spectrum of an output of the second optical multiplexer 540, and FIG. 6C shows an example of a channel spectrum of an output of the optical interleaver 550. In FIG. 6A, F−100, F, and F+100 denote the channel frequencies corresponding to the channel wavelengths of the first optical multiplexer 530, and reference numeral 610 denotes the first optical signal. In FIG. 6B, F−50 and F+50 denote the channel frequencies corresponding to the channel wavelengths of the second optical multiplexer 540, and reference numeral 620 denotes the second optical signal. Referring to FIGS. 6A and 6B, in the first optical multiplexer 530 and the second optical multiplexer 540, the channel frequencies corresponding to the channel wavelengths are spaced apart by 50 GHz. In FIG. 6C, F−100, F−50, F, F+50, and F+100 denote the channel frequencies corresponding to the channel wavelengths of the optical interleaver 550. The channel frequencies of the optical interleaver 550 include the channel frequency of the first optical multiplexer 530 and the channel frequency of the second optical multiplexer 540. Referring to FIG. 6C, the output of the optical interleaver 550 has a channel spectrum having a channel spacing of 50 GHz.

In the examples shown in FIG. 6, wavelengths of the first optical carrier and the second optical carrier are selected so that the first optical signal 610 and the second optical signal 620 of the dual-carrier optical transceiver 220 correspond to the adjacent channels. However, the wavelengths of the first optical carrier and the second optical carrier may be selected so that the first optical signal and the second optical signal of the dual-carrier optical transceiver 220 correspond to the channels that are not adjacent (for example, the spacing is 150 GHz).

In the receiving process, contrary to the transmitting process, the signal shown in FIG. 6C is input to the optical de-interleaver 580 and the optical de-interleaver 580 demultiplexes the input signal to output a signal including the signal 610 shown in FIG. 6A to the first demultiplexer 560 and output a signal including the signal 620 shown in FIG. 6B to the second optical demultiplexer 570. The signal 610 of FIG. 6A is demultiplexed by the first optical demultiplexer 560 and output to the dual-carrier optical transceiver 220 and the signal of FIG. 6B is demultiplexed by the second optical demultiplexer 570 and output to the dual-carrier optical transceiver 220. The two optical signals 610 and 620 are received by the dual-carrier optical transceiver 220.

FIG. 7 shows a configuration of an interface apparatus between a dual-carrier optical transceiver and a WDM optical transmission line according to another exemplary embodiment of the present invention.

According to the above-described exemplary embodiments, the first and second optical signals from the dual-carrier optical transceiver are transmitted using two wavelength channels of the WDM optical transmission system. Differently from the above exemplary embodiments, according to this exemplary embodiment, the first and second optical signals from the dual-carrier optical transceiver are transmitted using one wavelength channel of the WDM optical transmission system.

Referring to FIG. 7, the dual-carrier optical transceiver 220, an optical interleaver 720, and an optical de-interleaver 740 are provided in the same line card 710.

The optical interleaver 720 receives the first optical signal and the second optical signal from the dual-carrier optical transceiver 220 and multiplexes the signals to output the signals to an optical multiplexer 730. The number of outputs of the optical interleaver 720 is one and the output of the optical interleaver 720 also becomes an output of the line card 710.

The optical multiplexer 730 receives an optical signal from a dual-carrier optical transceiver other than the dual-carrier optical transceiver 220 or a general optical transceiver together with the optical signal from the optical interleaver 720 and multiplexes the received optical signals to output the signals to the optical transmission line 260.

The optical demultiplexer 750 receives a multiplexed optical signal including optical signals obtained by multiplexing the first received optical signal and the second received optical signal from the optical transmission line 270 and demultiplexes the signal. Among the demultiplexed optical signals, the optical signal obtained by multiplexing the first received optical signal and the second received optical signal is output to the optical de-interleaver 740. The other demultiplexed optical signals are output to an optical de-interleaver included in a line card other than the line card 710 or a general optical transceiver. The optical de-interleaver 740 demultiplexes the optical signal obtained by multiplexing the first received optical signal and the second received optical signal to output the signals to the dual-carrier optical transceiver 220.

In this exemplary embodiment, the two input wavelengths of the optical interleaver/de-interleaver 720 and 740 correspond to the wavelengths of the first optical carrier and the second optical carrier of the dual-carrier optical transceiver 220. Two input frequencies that correspond to the two input wavelengths of the optical interleaver/de-interleaver 720 and 740 are spaced apart from each other at a predetermined interval at both sides with a specific channel frequency of the optical multiplexer/demultiplexer 730 and 750 at a center thoseof.

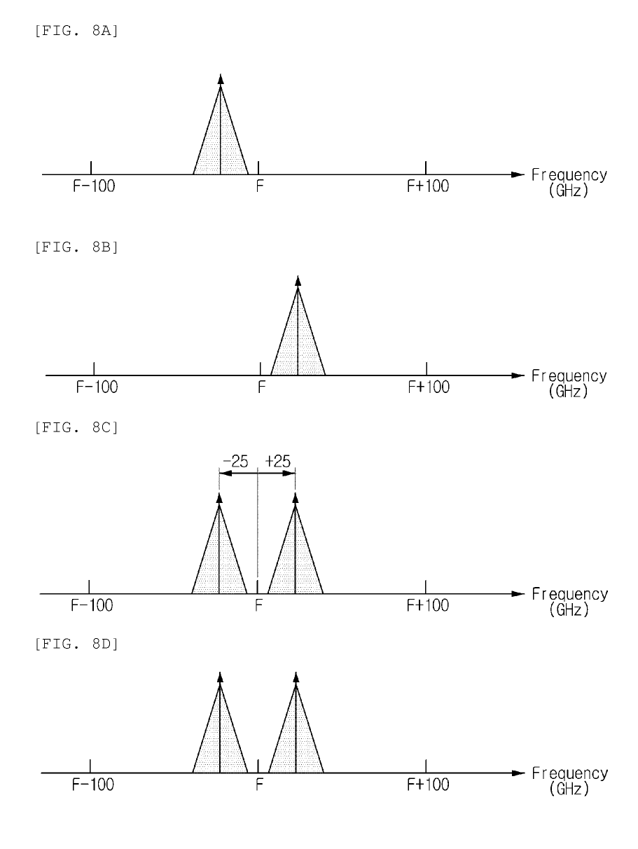

FIGS. 8A and 8B show spectrums of the two input optical signals of the optical interleaver 720, FIG. 8C shows a spectrum of an output optical signal of the optical interleaver 720, and FIG. 8D shows an example of a channel spectrum of an output of the optical multiplexer 730. In FIGS. 8A and 8B, the frequencies of the two input optical signals of the optical interleaver 720 are spaced apart from each other by a frequency (for example, 25 GHz) smaller than half of a channel spacing of the optical multiplexer 730 at both sides with a channel frequency F of the optical multiplexer 730 at a center thoseof (F−25, F+25). Therefore, the output optical signals of the optical interleaver 720 are formed at positions of frequencies F−25 and F+25 GHz. In the examples shown in FIG. 8, the channel spacing of the optical multiplexer 730 is 100 GHz. Accordingly, the output of the optical multiplexer 730 has a channel spectrum shown in FIG. 8D.

In the receiving process, contrary to the transmitting process, a signal shown in FIG. 8D is input to the optical demultiplexer 750 and the optical demultiplexer 750 demultiplexes the signal to output a signal shown in FIG. 8C to the optical de-interleaver 740. The optical de-interleaver 740 demultiplexes the signal to output the signals shown in FIGS. 8A and 8B to the dual-carrier optical transceiver 220. The two optical signals of FIGS. 8A and 8B are received by the dual-carrier optical transceiver 220.

According to the exemplary embodiment, two optical signals from the dual-carrier optical transceiver may be transmitted using a signal wavelength channel of the WDM optical transmission system.

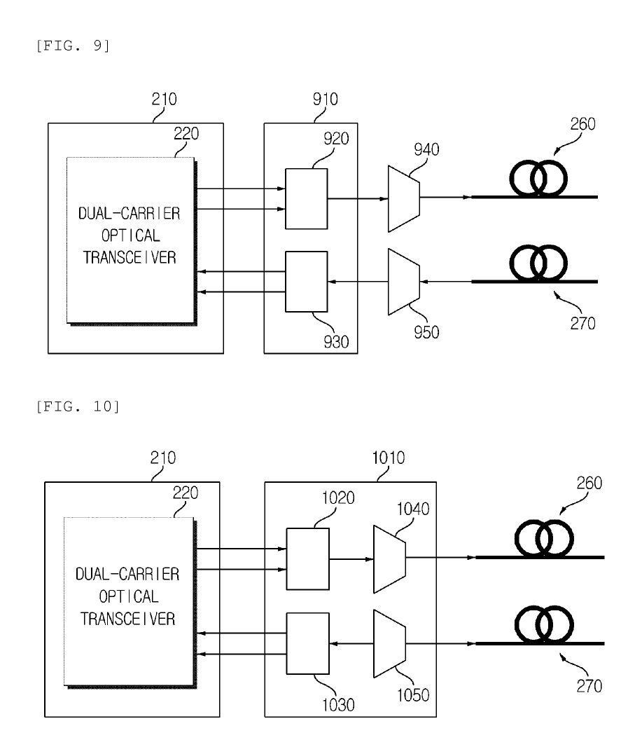

FIG. 9 shows a configuration of an interface apparatus between a dual-carrier optical transceiver and a WDM optical transmission line according to still another exemplary embodiment of the present invention.

This exemplary embodiment is a modified example of the interface apparatus shown in FIG. 7. Excepting that an optical interleaver 920 and an optical de-interleaver 930 are provided in a separate line card 910, not in the line card 210 including the dual-carrier optical transceiver 220, the operation and the function are same as those of the exemplary embodiment shown in FIG. 7.

FIG. 10 shows a configuration of an interface apparatus between a dual-carrier optical transceiver and a WDM optical transmission line according to still yet another exemplary embodiment of the present invention.

This exemplary embodiment is a modified example of the interface apparatus shown in FIG. 7. Excepting that an optical interleaver 1020, an optical de-interleaver 1030, an optical multiplexer 1040, and an optical demultiplexer 1050 are provided in the same line card 1010, the operation and the function are same as those of the exemplary embodiment shown in FIG. 7.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An interface apparatus between a dual-carrier optical transceiver and a WDM (wavelength division multiplexing) optical transmission line, comprising:
an optical multiplexer configured to receive a first optical signal modulated by a first optical carrier and a second optical signal modulated by a second optical carrier from the dual-carrier optical transceiver, and multiplex the first optical signal and the second optical signal to output the signals to the optical transmission line; and
an optical demultiplexer configured to receive the multiplexed optical signal from the optical transmission line and demultiplex the multiplexed optical signal to output the signals to the dual-carrier optical transceiver.

2. The interface apparatus of claim 1, wherein a channel wavelength of the optical multiplexer includes a wavelength of the first optical carrier and a wavelength of the second optical carrier.

3. The interface apparatus of claim 1, wherein a channel spacing of the multiplexer is 50 GHz or 100 GHz.

4. An interface apparatus between a dual-carrier optical transceiver and an optical transmission line, comprising:
a first optical multiplexer configured to receive a first optical signal modulated by a first optical carrier from the dual-carrier optical transceiver, and multiplex the first optical signal together with another optical signal to output the signals;
a second optical multiplexer configured to receive a second optical signal modulated by a second optical carrier from the dual-carrier optical transceiver, and multiplex the second optical signal together with another optical signal to output the signals; and
an optical interleaver configured to multiplex an output of the first multiplexer and an output of the second multiplexer to output the outputs to the optical transmission line.

5. The interface apparatus of claim 4, wherein a channel spacing of the first optical multiplexer and the second optical multiplexer is twice a channel spacing of the optical interleaver.

6. The interface apparatus of claim 4, wherein channel frequencies of the first optical multiplexer and the second optical multiplexer are spaced apart from each other.

7. The interface apparatus of claim 4, wherein a channel spacing of the first optical multiplexer and the second optical multiplexer is 100 GHz, channel frequencies are spaced apart from each other by 50 GHz, and a channel spacing of the optical interleaver is 50 GHz.

8. The interface apparatus of claim 4, wherein a channel wavelength of the first optical multiplexer includes a wavelength of the first optical carrier and a channel wavelength of the second optical multiplexer includes a wavelength of the second optical carrier.

9. An interface apparatus between a dual-carrier optical transceiver and an optical transmission line, comprising:
an optical interleaver configured to receive a first optical signal modulated by a first optical carrier and a second optical signal modulated by a second optical carrier from the dual-carrier optical transceiver, and multiplex the first optical signal and the second optical signal to output the signals; and
an optical multiplexer configured to multiplex and output an output to the optical interleaver together with another optical signal.

10. The interface apparatus of claim 9, wherein two input frequencies corresponding to two input wavelengths of the optical interleaver are spaced apart from each other at a predetermined interval at both sides with a specific channel frequency of the optical multiplexer at a center thoseof.

11. The interface apparatus of claim 9, wherein two input frequencies corresponding to two input wavelengths of the optical interleaver are spaced apart by a frequency smaller than half of a channel spacing of the optical multiplexer at both sides with a specific channel frequency of the optical multiplexer at a center thoseof.

12. The interface apparatus of claim 9, wherein two input wavelengths of the optical interleaver correspond to wavelengths of the first optical carrier and the second optical carrier.

13. The interface apparatus of claim 9, wherein a channel spacing of the optical multiplexer is 100 GHz, and two input frequencies corresponding to two input wavelengths of the optical interleaver are spaced apart by 25 GHz at both sides with a specific channel frequency of the optical multiplexer at a center thoseof.

14. The interface apparatus of claim 9, wherein the dual-carrier optical transceiver and the optical interleaver are provided in the same line card.

15. The interface apparatus of claim 9, wherein the dual-carrier optical transceiver and the optical interleaver are provided in separate line cards.

16. The interface apparatus of claim 9, wherein the optical interleaver and the optical multiplexer are provided in the same line card.
